(19) United States
(12) Patent Application Publication
(10) Pub. No.: US 2008/0181095 A1
(43) Pub. Date: Jul. 31, 2008

(54) Method and Apparatus for Impairment Correlation Estimation in Multi-Antenna Receivers

(76) Inventor: Kambiz C. Zangi, Chapel Hill, NC (US)

Correspondence Address: COATS & BENNETT, PLLC, 1400 Crescent Green, Suite 300, Cary, NC, 27518, US

(21) Appl. No.: 11/668,185

(22) Filed: Jan. 29, 2007

(51) Int. Cl. H04J 11/00

(52) U.S. Cl. 370/208

(57) ABSTRACT

According to a method and apparatus taught herein, signal impairment correlations across antennas in a multi-antenna receiver are determined using data values rather than pilot values in a multi-frequency signal received at each of the receiver antennas. For example, in an OFDM signal chunk having a number of data sub-carriers and a smaller number of pilot sub-carriers, processing herein determines received signal correlation estimates across the receiver antennas based on at least the data sub-carriers within the chunk. Impairment correlation estimates are then derived from the received signal correlation estimates and channel estimates, which may be based on the pilot sub-carriers received in the same and/or other OFDM chunks. This processing enables the receiver to maintain accurate estimates of signal impairment correlations for interference suppression, even in the presence of very low pilot density.

### BACKGROUND

1. Field of the Invention

The present invention generally relates to impairment correlation estimation, and particularly relates to impairment correlation estimation in multi-antenna receivers, such as a multi-antenna mobile terminal configured for Orthogonal Frequency Division Multiplex (OFDM) signal reception.

2. Background

Multi-antenna receivers enable potentially robust interference suppression processing. For example, a multi-antenna receiver can be configured to suppress interference using interference rejection combining (IRC) or minimum-mean square error (MMSE) detection. However, regardless of the particular interference suppression approach taken by the receiver, effective suppression generally requires knowledge of the (propagation) channels between the receiver antennas and the desired signal transmitter(s), and knowledge of the signal impairment correlation between receiver antennas.

Providing a practical basis for such knowledge at the receiver can be challenging. For example, an OFDM signal comprises a plurality of sub-carriers, usually at regularly spaced frequencies, including a number of data sub-carriers, i.e., information-bearing signals, and a smaller number of pilot sub-carriers. Conventionally, OFDM receivers use the pilot sub-carriers for both channel estimation and signal impairment correlation estimation.

Because signal impairment correlation can change rapidly and, more so than channel characteristics, may be significantly different across even small frequency intervals at any given time instant, a relatively high number of pilot sub-carriers is required. That is, the pilot density in an OFDM signal must be relatively high for accurate estimation of received signal impairment correlation by a conventional OFDM receiver. According to one measure, pilot density reflects the number of pilot sub-carriers as compared to the total number of (pilot and data) sub-carriers within a defined OFDM “chunk” representing a two-dimensional block within the overall OFDM signal time-frequency grid. An OFDM chunk thus spans a given number of sub-carrier frequencies in one dimension and a number of OFDM symbol times in the other dimension.

Pilot densities of twelve percent or higher are known in contemporary OFDM-based communication systems, such as in the IEEE 802.16 (WiMax) standards. While higher pilot densities improve interference suppression in conventional receivers, the higher densities detract from system efficiency by reducing the number of sub-carriers available for transmitting data in any given time instant.

### SUMMARY

In OFDM and other multi-frequency signal types, the allocation of frequencies for pilot use must be great enough for accurate estimation of signal impairment correlation by interference-suppressing receivers that conventionally estimate such correlations using received pilots. To reduce pilot density requirements while simultaneously providing a basis for accurate estimation of signal impairment correlations in multi-antenna receivers, an apparatus and corresponding method disclosed herein calculate impairment correlations between receiver antennas for a received OFDM or other multi-frequency signal using the data components of the received signal, while using the pilot components for channel estimation.

In one or more embodiments, a method of estimating impairment correlations between receiver antennas of an OFDM receiver includes generating channel estimates based on pilot sub-carriers in an OFDM signal received at each of two or more receiver antennas. The method further includes determining received signal correlation estimates for the OFDM signal across the receiver antennas based on the OFDM signal, including data sub-carriers of the OFDM signal, and calculating impairment correlation estimates for the OFDM signal across the receiver antennas based on the channel estimates and the received signal correlation estimates. For example, at least one embodiment of the method comprises determining desired signal correlation estimates from the channel estimates, corresponding to a desired signal component of the OFDM signal, and determining impairment correlation estimates as a difference between the received signal correlation estimates and the desired signal correlation estimates. In at least one such embodiment, the method includes determining the received signal correlation estimates and the corresponding impairment correlation estimates on a per OFDM chunk basis.

That is, the method uses data sub-carriers within each given OFDM chunk of interest to calculate an impairment correlation estimate for that OFDM chunk. Channel estimation also may be carried out on a per OFDM chunk basis, using just the pilot carriers (at a low density within the chunk) to generate channel estimates for the chunk. Alternatively, channel estimation may use pilot sub-carries from more than one chunk and/or combine channel estimation across chunks.

In a corresponding apparatus embodiment, a receiver circuit for estimating signal impairment correlations between receiver antennas of an OFDM receiver comprises one or more processing circuits. The processing circuits are configured to generate channel estimates based on pilot sub-carriers in an OFDM signal received at each of two or more receiver antennas, and determine received signal correlation estimates for the OFDM signal across the receiver antennas based on the OFDM signal, including the data sub-carriers. The processing circuits are also configured to calculate impairment correlation estimates for the OFDM signal across the receiver antennas based on the channel estimates and the received signal correlation estimates. Again, the received signal correlation and impairment correlation estimations may be performed on an OFDM chunk basis, wherein the receiver circuit uses the data sub-carriers within each given OFDM chunk of interest to determine the received signal correlation estimates and calculate the corresponding impairment correlation estimates.

Of course, the present invention is not limited to the above features and advantages. Indeed, those skilled in the art will recognize additional features and advantages upon reading the following detailed description, and upon viewing the accompanying drawings. BRIEF DESCRIPTION OF THE DRAWINGS

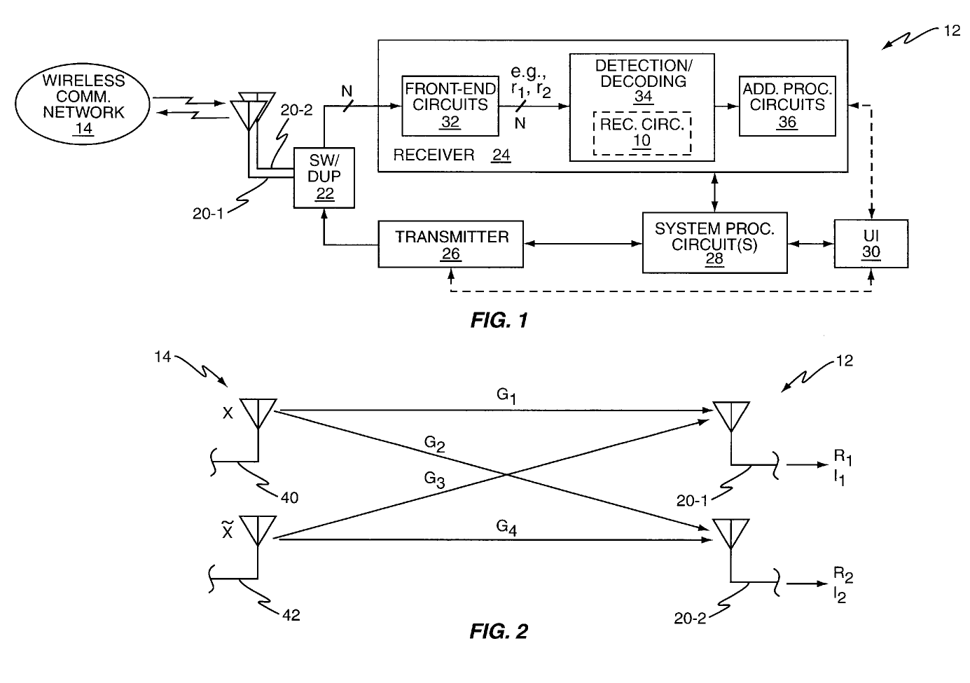

FIG. 1 is a block diagram of a wireless communication device, including an embodiment of a receiver circuit configured to estimate signal impairment correlations using data sub-carriers in a received multi-frequency signal.

FIG. 2 is a diagram of an example desired/interfering signal environment.

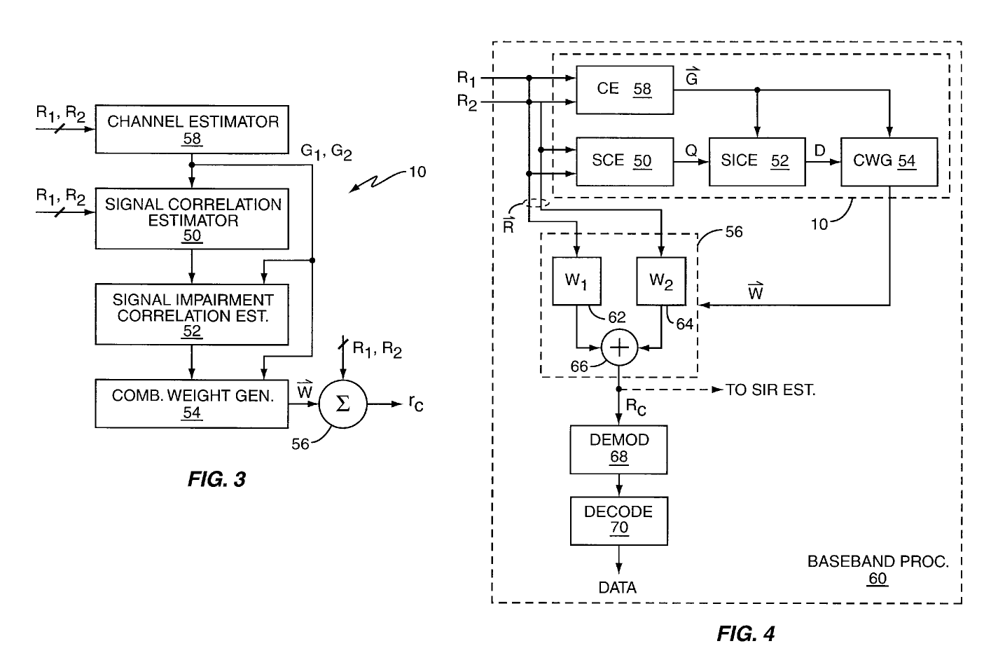

FIG. 3 is a block diagram of circuit details for one embodiment of the receiver circuit of FIG. 1.

FIG. 4 is a block diagram of circuit details for another embodiment of the receiver circuit of FIG. 1.

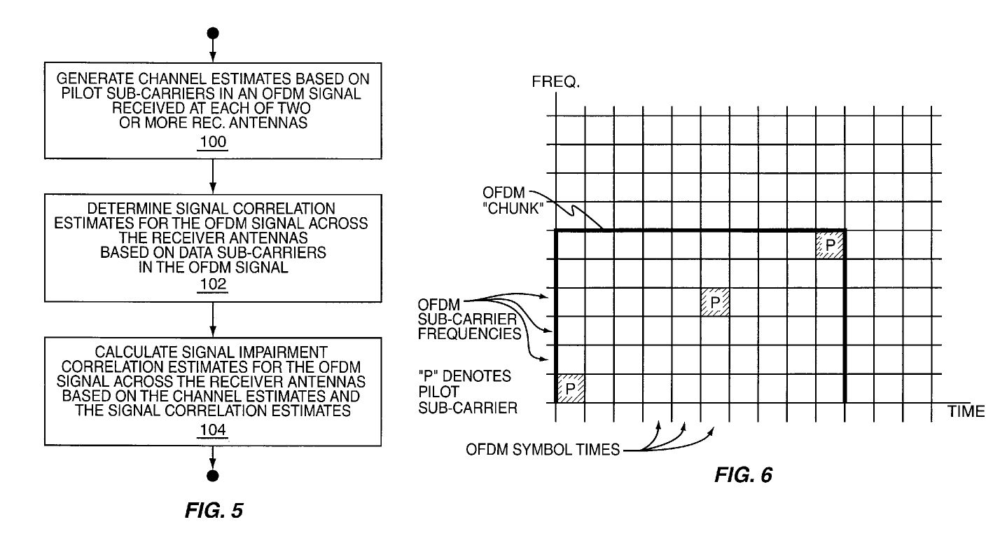

FIG. 5 is a logic flow diagram for one embodiment of a method of estimating signal impairment correlations.

FIG. 6 is a diagram of an OFDM chunk, such as can be used in chunk-based processing embodiments described herein.

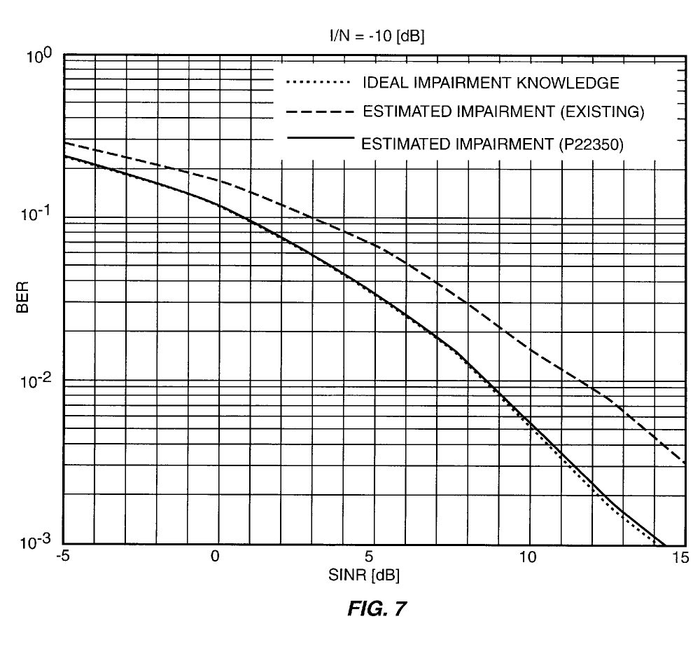

FIGS. 7-9 are graphs illustrating example Bit Error Rate (BER) performance obtained with an embodiment of impairment correlation estimation as taught herein.

### DETAILED DESCRIPTION

FIG. 1 illustrates a receiver circuit 10 that is of particular interest herein regarding its structure and operation for estimating impairment correlations in a multi-antenna receiver environment. By way of non-limiting example, the receiver circuit 10 appears within a wireless communication device 12, such as a cellular radiotelephone or other wireless communication terminal, module, or system, communicatively coupled to a supporting wireless communication network 14. In at least one embodiment, the wireless communication network 14 is a frequency-division multiplexed network, e.g., a network transmitting Orthogonal Frequency Division Multiplexing (OFDM) signals. Correspondingly, in at least one embodiment, the wireless communication device 12 is configured for multi-frequency signal reception and processing.

Continuing with the illustrated example, the wireless communication device 12 includes a number of receiver antennas 20 (20-1 and 20-2 are illustrated), a switch/duplexer circuit 22, a receiver 24, a transmitter 26, system processing circuits 28 (e.g., one or more microprocessors), and a user interface 30. With the understanding that the illustrated implementation details are subject to variation depending upon the level integration and manner of circuit implementation, the receiver 24 includes front-end circuits 32 for filtering and down sampling the antenna-received signals. The receiver 24 further includes decoding/detection circuits 34 for detecting received symbols and decoding them, and one or more additional processing circuits 36, which may provide further signal processing, signal quality estimation, communication link control, and system processing interfacing.

Note that the illustration depicts the receiver circuit 10 integrated within the decoding/detection circuits 34 of the receiver 24, but other arrangements are contemplated. Actual placement of the receiver circuit 10 within the digital processing environment of a communication receiver is quite flexible, and it is necessary only that the receiver circuit 10 has access to the appropriate signal information in operation.

During such operation, the wireless communication network 14 transmits a multi-frequency signal, e.g., an OFDM signal, to the wireless communication device 12 from N transmit antennas, where N equals 1, 2, or more antennas. Note that more favorable operation of the impairment correlation estimation taught herein is enjoyed where M>N, i.e., where there are more antennas at the receiver than at the desired signal transmitter.

For example, FIG. 2 illustrates a typical multipath transmission scenario where a network transmitter 40 transmits a desired OFDM symbol X to the wireless communication device 12 through multipath propagation channels G₁ and G₂, corresponding to the receiver antennas 20-1 and 20-2. Thus, a received signal R₁ is associated with the transmitted OFDM signal as received on antenna 20-1 through channel G₁, and a received signal R₂ is associated with the transmitted OFDM signal as received on antenna 20-2 through channel G₂ . (Note that G₁ and G₂ may comprise medium channel response estimates reflecting the propagation path characteristics, or, more advantageously in some implementations, net channel responses reflecting path response and receiver/transmitter response characteristics.)

As part of received signal processing, the wireless communication device 12 maintains estimates of G₁ and G₂, to compensate the received signal for channel effects. However, it will be understood that the received signal suffers a certain amount of interference (I₁ for R₁, and I₂ for R₂). At least a portion of these interference components arises from the simultaneous transmission of other information, for example, an interfering OFDM symbol X simultaneously transmitted by transmitter 42. Such interfering signals typically (but not necessarily) travel through different propagation paths (G₃ and G₄ are illustrated as examples) which are unknown to the wireless communication device 12, and are not explicitly estimated by it. Nonetheless, the wireless communication device 12 can suppress such interference by observing the correlation of impairments across its multiple receiver antennas caused by the interfering signal.

To that end, FIG. 3 illustrates one functional circuit arrangement for the receiver circuit 10. The illustrated embodiment of the receiver circuit 10 comprises a received signal correlation estimator 50 and an impairment correlation estimator 52, and further includes, or is associated with, a combining weight generator 54 and signal combining circuit 56, and a channel estimator 58.

As a further example, FIG. 4 illustrates a similar arrangement as implemented in a baseband processor 60, which may comprise at least a portion of the receiver 24. The baseband processor 60 in one embodiment comprises one or more digital signal processors, microcontrollers, microprocessors, or other digital processing circuit in which the desired signal impairment correlation estimation processing is implemented in hardware, software, or any mix thereof.

Baseband processing implementation complements a high degree of circuit integration. For example, the illustration depicts the combined implementation of the receiver circuit 10, the combining circuit 56 (weighting circuits 62, 64, and summing circuit 66), along with demodulation and decoding circuits 70. Of course, other arrangements are possible.

Regardless of the particular functional circuit arrangement adopted, FIG. 5 illustrates one embodiment of a method of estimating signal impairment correlations. It should be understood that the sequential structure of the logic flow diagram does not necessarily indicate ordered processing steps. Where desired or possible, the illustrated processing may be carried out in another order and/or at least some processing steps may be performed concurrently in whole or in part.

With those qualifiers in mind, the illustrated method of estimating signal impairment correlations for an OFDM signal in a multi-antenna receiver comprises generating channel estimates based on pilot sub-carriers in the OFDM signal as received at each of the two or more receiver antennas, e.g., antennas 20-1 and 20-2 (Step 100). Processing continues with determining received signal correlation estimates for the OFDM signal across the receiver antennas 20-1 and 20-2 based on sub-carriers in the OFDM signal, including at least data sub-carriers, (Step 102), and calculating impairment correlation estimates for the OFDM signal across the receiver antennas 20-1 and 20-2 based on the channel estimates and the received signal correlation estimates (Step 104).

In at least one embodiment, processing continues with using the impairment correlation estimates in the generation of combining weights, \vec{W}, which are used to combine the antenna-specific received signals R₁, and R₂, corresponding to the OFDM signal as received on antennas 20-1 and 20-2. The resultant combined signal R_{C} is improved by the suppression of correlated impairment via use of the combining weights \vec{W}, and may be demodulated and decoded and/or used as a basis for received signal quality estimation, which may serve as a basis for communication link adaptation.

The above processing, or variations of it, may be carried out on an OFDM “chunk” basis. Thus, FIG. 6 illustrates a two-dimensional OFDM time-frequency grid, having a number of OFDM symbol times spanning in one dimension and a number of OFDM sub-carriers spanning in the other dimension. The overall OFDM time-space grid may be subdivided into a plurality of OFDM chunks on a continuing time basis.

With the above chunk formulation as an example backdrop, the various received and generated signals and values may be represented as functions of OFDM symbol time, t, and OFDM sub-carrier frequency, ω. Broadly, consider an OFDM system with one transmit antenna and M receive antennas. Let X (ω,t) be the desired data symbols and let P(ω,t) be the pilots. Further, assume that both X (ω,t) and P(ω,t) go through the same channels \vec{G}, where [symbol] denotes a vector. (Note that the components of \vec{G} themselves may be multipath channel vectors.)

The (composite) received signal over a data symbol is given as,

\vec{R} (ω,t)=X(ω,t)\vec{G}(ω,t)+\vec{Z}(ω,t)+\vec{N}(ω,t) Eq. (1)

where X(ω,t)\vec{G}(ω,t) corresponds to a desired signal component of the received signal, \vec{Z}(ω,t) corresponds to an impairment component of the received signal, and \vec{N}(ω,t) corresponds to a thermal/other noise component of the received signal. For the 20-1, 20-2 two-antenna case, \vec{R}(ω,t)=[R₁(ω,t),R₂(ω,t)]^{T}, \vec{G}(ω,t)=[G₁(ω,t),G₂(ω,t)]^{T},\vec{Z}(ω,t)=[Z₁(ω,t),Z₂(ω,t)]^{T}, and \vec{N}(ω,t)=[N₁(ω,t),N₂(ω,t)]. In general, \vec{R}(ω,t) is an M×1 vector whose m-th element is the received signal at the m-th receiver antenna, for OFDM sub-carrier frequency ω and OFDM symbol time t. As explained before, X(ω,t) is the scalar-valued desired signal, \vec{Z}(ω,t) is an [M,1] vector of (correlated) signal impairment across the receiver antennas, and \vec{N}(ω,t) is an [M,1] vector of thermal noise at the receiver.

One may combine the correlated impairment and thermal noise terms into an overall impairment term as,

\vec{I}(ω,t)=\vec{Z}(ω,t)+\vec{N}(ω,t) Eq. (2)

One may thus express the received signal in multi-antenna vector form as,

\vec{R}(ω,t)=X(ω,t)\vec{G}(ω,t)+\vec{I}(ω,t) Eq. (3)

and thereby represent the (composite) received signal \vec{R}(ω,t) as a desired signal component X(ω,t)\vec{G}(ω,t) and an impairment component \vec{I}(ω,t).

As noted, knowledge of the correlation of the impairment component across receive antennas allows the receiver circuit 10 to improve reception performance, such as by generating antenna combining weights that account for the impairment correlation. However, directly estimating the impairment correlation accurately is challenging, particularly where the received signal has low pilot density. To that end, one or more receiver embodiments taught herein advantageously estimate impairment correlation across receive antennas based on generating channel estimates for a received signal, as received on each of two or more antennas of interest, determining the received signal correlation across the antennas, and calculating the impairment correlation across the antennas based on the channel estimates and the received signal correlation.

More particularly, as will be detailed below, the channel estimates determined with respect to each antenna may be used to estimate the correlation across antennas for a desired signal component of the received signal. With that determination, the correlation of impairment across the antennas may be determined by subtracting the desired signal correlations from the overall received signal correlations, which may be calculated from received signal samples for the antennas of interest.

With the above in mind, in one or more embodiments, the channel estimator 58 is configured to use the (known) pilot symbols received on pilot sub-carriers of interest to generate channel estimates, thus one may assume that \vec{G}(ω,t) is known to the receiver 24 with sufficient accuracy. Because the pilot symbols on the pilot sub-carriers may be transmitted at a different power than the data symbols carried on the data sub-carriers, the channel estimator 58 or other functional element may be configured to compute a traffic-to-pilot scaling value. That value can be determined by relating the variance (Var) of the pilot symbols and the data symbols as,

Var(P(ω,t))=c·Var(X(ω,t)) Eq. (4)

where the scalar value c represents the scaling factor. Such calculations may be normalized, or otherwise referenced to one, such that the traffic symbol variance (power) is expressed as a fraction of the pilot symbol variance (power).

In any case, given \vec{R}(ω,t) and \vec{G}(ω,t), the receiver circuit 10 may construct an estimate of the covariance of the impairment component of the composite received signal across the M receiver antennas as,

D(ω,t)=E{\vec{I}(ω,t)·\vec{I}(ω,t)^{H}} Eq. (5)

where ·^{H} denotes the Hermitian transpose, the bold variable notation denotes a matrix value, e.g., for \vec{I} of dimension 2×1, D is a 2×2 matrix, and E{·} is the expected value function. That is, the impairment covariance matrix D(ω,t) represents an estimate of the correlation across antennas for the impairment component of the received signal. This disclosure refers to D(ω,t) and equivalent representations as “impairment correlation estimates.”

For the two-receiver antenna case,

$$D ( ω , t ) = E \{ [ {I}_{1} ( ω , t ) {I}_{2} ( ω , t ) ] \cdot [ \begin{matrix}{I}_{1}^{*} ( ω , t ) \\ {I}_{2}^{*} ( ω , t )\end{matrix} ] \} \qquad Eq . ( 6 )$$

where * denotes the conjugate. More generally expressed for the two receiver antenna case,

$$D ( ω , t ) = [ \begin{matrix}{δ}_{{I}_{1}}^{2} & {ρ}_{12} \\ {ρ}_{12}^{*} & {δ}_{{I}_{2}}^{2}\end{matrix} ] \qquad Eq . ( 7 )$$

where δ_{I}_{₁}² is the power (autocorrelation) of signal impairment on a first receiver antenna, e.g., 20-1, δ_{I}_{₂}² is the power (autocorrelation) of signal impairment on a second receiver antenna, e.g., antenna 20-2, ρ₁₂ is the cross-correlation of the impairments on the first and second antennas and ρ₁₂* is the conjugate of ρ₁₂.

As taught herein, the impairment correlation estimate D is obtained as a function of the received signal correlation estimates and the pilot-based channel estimates, where the received signal correlation estimates are determined using data sub-carriers, meaning that a high pilot density within the received signal is not required for accurate impairment correlation estimation. (Of course, pilot sub-carriers additionally may be considered in the computation of the received signal correlation estimates, but, because data sub-carriers are considered, high pilot density is not needed to obtain meaningful correlation results for the received signal.)

At least one embodiment of the received signal correlation estimator 50 is configured to compute received signal correlation estimates as the correlation between different elements of the received signal \vec{R}(ω,t), for those OFDM symbol times and sub-carrier frequencies of interest. For example, the receiver circuit 10 may be configured to determine impairment correlation estimates on a per OFDM chunk basis, wherein the impairment correlation estimates are calculated for individual OFDM chunks using the sub-carriers within each such chunk.

The estimate of received signal correlation across two or more antennas may be expressed as a covariance matrix of the received signal \vec{R}(ω,t), where the covariance matrix is given as,

E{\vec{R}(ω,t)·\vec{R}(ω,t)^{H}}=\vec{G}(ω,t)·Var(X(ω,t))·\vec{G}(ω,t)^{H}+D(ω,t) Eq. (8)

based on the assumption that the transmitted symbols are statistically independent of the impairment. For notational convenience, one may denote the covariance matrix of the received signal as,

Q(ω,t)=E{\vec{R}(ω,t)·\vec{R}(ω,t)^{H}} Eq. (9)

where Q(ω,t) has dimension M×M. From Eq. (9). Thus, for purposes of this discussion, Q(ω,t) represents one approach for determining received signal correlation estimates across antennas for the received signal \vec{R}(ω,t).

The covariance matrix Q(ω,t) also may be expressed as,

Q(ω,t)=d\vec{G}(ω,t)·\vec{G}(ω,t)^{H}+D(ω,t) Eq. (10)

where d is the average variance of the transmitted symbols corresponding to the received signal. The value d may be represented as,

d=βVar(X(t))+(1−β)Var(P(t)) Eq. (11)

where β represents the portion of the transmitted symbols that are data symbols, X(t), and (1−β) represents the portion of the transmitted symbols that are pilot symbols, P(t). The value of d therefore provides the appropriate traffic-pilot scaling. From Eq. (10), it follows that the impairment correlation, represented by the impairment covariance D, may be expressed as,

D(ω,t)=Q(ω,t)−d\vec{G}(ω,t)·\vec{G}(ω,t)^{H} Eq. (12)

From Eq. (12), one sees that the impairment correlation estimates D(ω,t) are calculated from the received signal impairment correlation estimates Q(ω,t) and the channel estimates \vec{G}(ω,t). More particularly, the channel estimates are used to determine the desired signal correlation estimates d\vec{G}(ω,t)·\vec{G}(ω,t)^{H}, which are scaled for traffic-to-pilot power differences, and the impairment correlation estimates are determined from the received signal correlation estimates and the desired signal correlation estimates.

Thus, the receiver circuit 10 calculates impairment correlation estimates for the received signal \vec{R}(ω,t) based on channel estimates derived from pilot information in the received signal, and from received signal correlations determined from samples of the received signal. More specifically, in at least one embodiment, the channel estimator 58 uses known pilots received on the pilot sub-carriers of a received OFDM signal to generate antenna-specific channel estimates \vec{G}(ω,t) and the impairment correlation estimator 50 uses unknown data symbols as observed on the OFDM signal data sub-carriers received at each of the receiver antennas to compute a received signal covariance Q(ω,t). As noted, the transmitted symbols commonly are scaled such that their average variance is one, thus a traffic-to-pilot scaling term d is easily determined.

The received signal covariance across antennas, which represents the received signal correlations, is readily determined by the received signal correlation estimator 50 as,

$$Q ( ω , t ) \approx \frac{1}{KL} {\sum }_{k = 1}^{K} {\sum }_{l = 1}^{L} \vec{R} ( {ω}_{k} , {t}_{l} ) \cdot {\vec{R}}^{*} ( {ω}_{k} , {t}_{l} ) \qquad Eq . ( 13 )$$

where * denotes the conjugate, K denotes the total number of OFDM data sub-carriers of interest, and L denotes the total number of OFDM symbol times of interest. For chunk-based processing, the index k ranges over the data sub-carriers included within an OFDM chunk of interest, and the index l ranges over the OFDM symbol times included within that OFDM chunk.

One sees that the impairment correlation estimator 52 thus may be configured to generate an accurate estimate of the impairment correlation across any number of receiver antennas of interest using the received signal correlation estimates determined from the received data sub-carriers and, optionally, the pilot sub-carriers as well, and the channel estimates determined from the relatively fewer pilot sub-carriers.

Thus, the signal processing method and apparatus described herein allow highly accurate impairment correlation estimation without requiring high pilot density. For example, it is known to use pilot densities at or above twelve-percent, while the teachings herein allow the use of pilot densities at or below ten percent. Indeed, with application of the teachings herein, accurate impairment correlation estimation may be maintained with pilot densities at or below three percent.

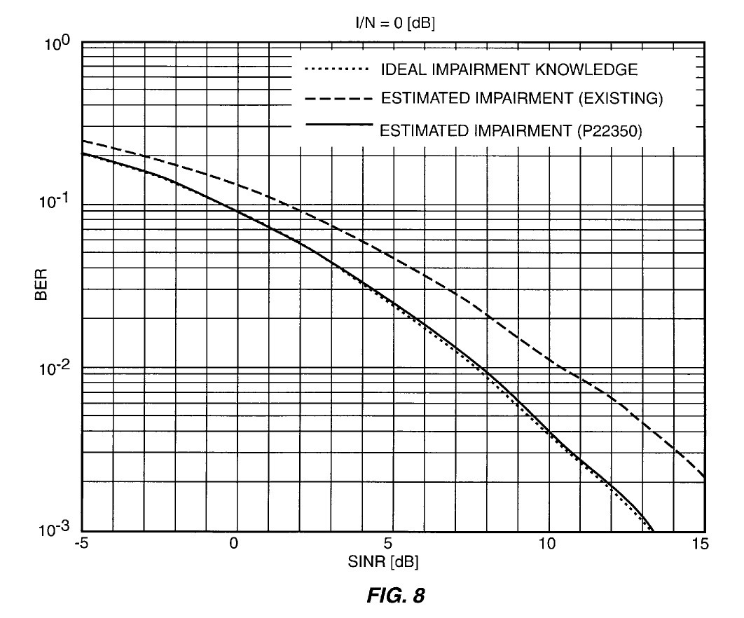

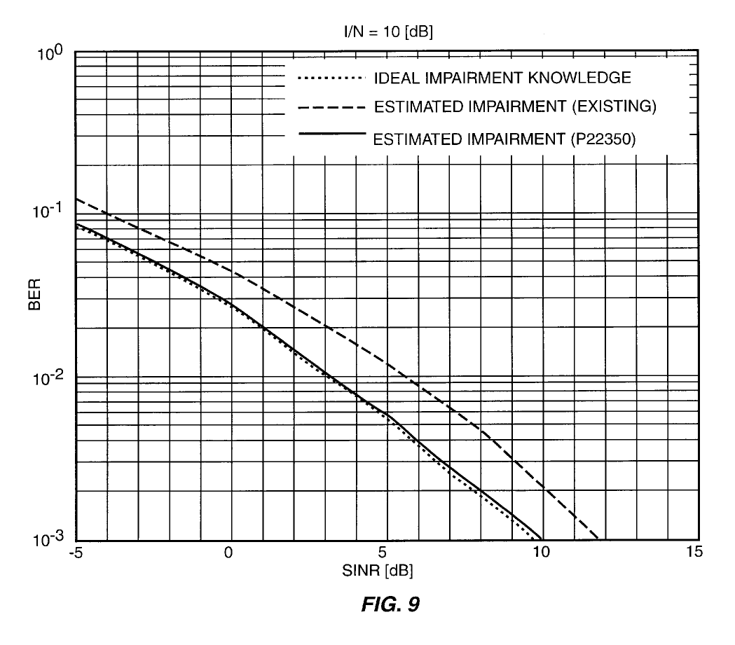

For illustration, FIGS. 7-9 depict impairment suppression performance for the methods and apparatus taught herein. In more detail, the performance illustrations assume a received OFDM signal having QPSK data symbol modulation. Each performance graph plots Bit Error Rate (BER) performance as a function of signal-to-noise-plus-interference ratios (SINR) for three different impairment scenarios. That is, for a total impairment (I=Z+N), FIG. 7 depicts performance for I/N=−10 dB, FIG. 8 corresponds to I/N=0 dB, and FIG. 9 corresponds to I/N=+10 dB. In all such performance graphs, SINR is computed as the power of the desired signal S over total impairment power (I+N). The graphs also assume chunk-based processing for OFDM chunks spanning eight OFDM symbol times and sixteen OFDM sub-carrier frequencies, with just two pilot data sub-carriers in each OFDM chunk. (For perspective, two pilot sub-carriers in an OFDM chunk having eight times sixteen sub-carriers in total is a pilot density of about one-and-a-half percent.)

One sees that with this low pilot density, existing impairment correlation techniques, which rely on the pilot sub-carriers for impairment correlation estimation over the OFDM chunk of interest, exhibit the worst performance in all illustrated impairment scenarios. Conversely, in all impairment scenarios, the impairment correlation estimation method taught herein nearly matches the performance that would be obtained by a receiver with perfect knowledge of the impairment correlation.

Referring back to FIG. 4 for a more detailed example of realizing the benefits of impairment correlation estimation as taught herein, one sees that the channel estimator (CE) 58 receives the down-sampled signal \vec{R}(ω,t) from the front-end circuits 32 and using pilot sub-carriers therein generates the channel estimates \vec{G}(ω,t). The received signal correlation estimator (RSCE) 50 also receives \vec{R}(ω,t) and correspondingly computes Q(ω,t) from data sub-carriers in \vec{R}(ω,t). In turn, the impairment correlation estimator (ICE) 52 computes the impairment correlation estimate D(ω,t) as a function of the channel estimates \vec{G}(ω,t) and the received signal correlation estimates Q(ω,t).

With that processing basis, the combining weight generator (CWG) 54 computes combining weights for combining the signal samples corresponding to the M receiver antennas 20. These combining weights may be expressed as,

\vec{W}=\vec{G}_{1×M}^{H}(ω,t)·D_{M×M}⁻¹(ω,t) Eq. (14)

Thus, weighting circuits 62 and 64 apply (complex) combining weights W₁ and W₂ to the R₁ and R₂ components of \vec{R}(ω,t), which suppress correlated impairments when the resulting weighted signals are combined into the combined received signal R_{C}. The combined signal may be demodulated/decoded and used for received signal quality estimation (R_{C}(ω,t)=\vec{W}\vec{R}(ω,t)).

Of course, those skilled in the art will appreciate that this disclosure presents a broad method of estimating impairment correlations between receiver antennas of an Orthogonal Frequency Division Multiplex (OFDM) receiver using the data sub-carriers in addition to, or in the alternative to the pilot sub-carriers. This approach enables accurate estimation of signal impairment correlations even with very low pilot densities in a multi-frequency received signal.

In at least one embodiment, the advantageous method disclosed herein includes generating channel estimates based on pilot sub-carriers in an OFDM signal received at each of two or more receiver antennas, and determining received signal correlation estimates for the OFDM signal across the receiver antennas based at least on the data sub-carriers in the OFDM signal. The method further includes calculating impairment correlation estimates for the OFDM signal across the receiver antennas based on the channel estimates and the received signal correlation estimates. The received signal correlation estimates may be expressed as the received signal covariance Q(ω,t), taken across the M receiver antennas, and the correspondingly calculated impairment correlation estimates may be expressed as the impairment covariance D(ω,t).

Additionally, as mentioned elsewhere herein, the receiver circuit 10 may be configured to perform estimation of impairment correlation on an OFDM chunk basis. In other words, the receiver circuit 10 may be configured to determine the received signal correlation estimates and calculate the impairment correlation estimates on an OFDM chunk basis.

Thus, the receiver circuit 10 (or other suitably configured processing entity) may be configured to implement a method wherein it receives an OFDM signal at each of two or more receiver antennas 20, and generates channel estimates for the OFDM signal based on pilot sub-carriers within one or more OFDM chunks of the OFDM signal. Such processing continues with generating estimates of the impairment correlation across the receiver antennas for individual OFDM chunks of interest based on data sub-carriers within the individual OFDM chunks of interest.

As a point of flexibility, the receiver circuit 10 may or may not generate the channel estimates \vec{G}(ω,t) on an OFDM chunk basis. In one embodiment, the channel estimator 58 generates channel estimates on an OFDM chunk basis, by estimating the channel conditions for a given OFDM chunk using the pilot sub-carriers within that chunk. In other embodiments, the channel estimator 58 generates channel estimates for a given chunk using the pilot sub-carriers in that chunk and pilot sub-carriers in one or more other chunks, or by combining channel estimates across two or more chunks, e.g., averaging across chunks.

In any case, determining the received signal correlation estimates on an OFDM chunk basis comprises determining the received signal correlation estimates for an OFDM chunk using the data sub-carriers in that OFDM chunk. Likewise, calculating the impairment correlation estimates on an OFDM chunk basis comprises determining the impairment correlation estimates for an OFDM chunk based on the received signal correlation estimates determined for that OFDM chunk.

In at least one embodiment, such as illustrated by Eq. (13), determining received signal correlation estimates for the OFDM signal across the receiver antennas based on data sub-carriers in the OFDM signal comprises determining a covariance of the OFDM signal as a function of received signal samples obtained from a number of data sub-carriers of interest in the OFDM signal. Further, as illustrated by Eq. (12) calculating impairment correlation estimates for the OFDM signal across the receiver antennas based on the channel estimates and the received signal correlation estimates comprises expressing the impairment correlation estimates as a function of the covariance of the OFDM signal and a product of the channel estimates scaled for a difference in traffic-to-pilot transmit powers. Further, determining a covariance of the OFDM signal as a function of received signal samples obtained from a number of data sub-carriers of interest in the OFDM signal comprises, for a number of OFDM data sub-carrier frequencies of interest, summing products of received signal samples and corresponding conjugates over a number of OFDM symbol times of interest. For example, the summations may be taken over the frequency (K) and time (L) indices of Eq. (13).

Of course, chunk-based processing and other details may be varied as needed or desired, in dependence on the communication protocols and standards at issue, for example. Moreover, the methods and apparatus taught herein may be applied to a variety of receiver applications and, particularly in the wireless communication network environment, may be applied both to downlink and uplink signal processing. In general, those skilled in the art will appreciate that the present invention is not limited by the foregoing description and accompanying drawings. Instead, the present invention is limited only by the claims and their legal equivalents.

What is claimed is:

1. A method of estimating impairment correlation between receiver antennas of an Orthogonal Frequency Division Multiplexing (OFDM) receiver, the method comprising:
generating channel estimates based on pilot sub-carriers in an OFDM signal received at each of two or more receiver antennas;
determining received signal correlation estimates for the OFDM signal across the receiver antennas based on data sub-carriers in the OFDM signal; and
calculating impairment correlation estimates for the OFDM signal across the receiver antennas based on the channel estimates and the signal correlation estimates.

2. The method of claim 1, further comprising determining the received signal correlation estimates and calculating the impairment correlation estimates on an OFDM chunk basis, wherein each OFDM chunk spans a number of OFDM symbol times and spans a number of OFDM sub-carrier frequencies.

3. The method of claim 2, further comprising generating the channel estimates on an OFDM chunk basis.

4. The method of claim 2, wherein determining the received signal correlation estimates on an OFDM chunk basis comprises determining the received signal correlation estimates for an OFDM chunk using the data sub-carriers in that OFDM chunk, and wherein calculating the impairment correlation estimates on an OFDM chunk basis comprises determining the impairment correlation estimates for an OFDM chunk based on the received signal correlation estimates determined for the data sub-carriers in that OFDM chunk.

5. The method of claim 4, further comprising generating the channel estimates on an OFDM chunk basis by generating channel estimates for an OFDM chunk using the pilot sub-carriers in that OFDM chunk.

6. The method of claim 4, further comprising generating the channel estimates across OFDM chunks by generating channel estimates for an OFDM chunk using the pilot sub-carriers in that OFDM chunk and one or more pilot sub-carriers from one or more other OFDM chunks, or by combining channel estimates across two or more OFDM chunks.

7. The method of claim 1, wherein determining received signal correlation estimates for the OFDM signal across the receiver antennas based on data sub-carriers in the OFDM signal comprises determining a covariance of the OFDM signal as a function of received signal samples obtained from a number of data sub-carriers of interest in the OFDM signal.

8. The method of claim 7, wherein calculating impairment correlation estimates for the OFDM signal across the receiver antennas based on the channel estimates and the received signal correlation estimates comprises determining desired signal correlation estimates for a desired signal component of the OFDM signal based on the channel estimates, and determining the impairment correlation estimates based on the received signal correlation estimates and the desired signal correlation estimates.

9. The method of claim 8, wherein determining desired signal correlation estimates based on the channel estimates includes scaling the channel estimates for a difference in traffic-to-pilot transmit powers.

10. The method of claim 7, wherein determining a covariance of the OFDM signal as a function of received signal samples obtained from a number of data sub-carriers of interest in the OFDM signal comprises, for a number of OFDM data sub-carrier frequencies of interest, summing products of received signal samples and corresponding conjugates over a number of OFDM symbol times of interest.

11. The method of claim 1, further comprising calculating combining weights as a function of the impairment correlation estimates, for combining of antenna-specific signal samples obtained from the OFDM signal.

12. The method of claim 11, further comprising processing the combined antenna-specific signal samples as a combined signal for at least one of transmit data decoding and received signal quality estimation.

13. The method of claim 1, wherein the OFDM signal comprises a low pilot density signal having a pilot density of ten percent or less.

14. A receiver circuit for estimating impairment correlations between receiver antennas of an Orthogonal Frequency Division Multiplex (OFDM) receiver, the receiver circuit comprising one or more processing circuits configured to:
generate channel estimates based on pilot sub-carriers in an OFDM signal received at each of two or more receiver antennas;
determine received signal correlation estimates for the OFDM signal across the receiver antennas based on data sub-carriers in the OFDM signal; and
calculate impairment correlation estimates for the OFDM signal across the receiver antennas based on the channel estimates and the received signal correlation estimates.

15. The receiver circuit of claim 14, wherein the one or more processing circuits comprise a received signal correlation estimator configured to determine the received signal correlation estimates, and an impairment correlation estimator configured to calculate the impairment correlation estimates.

16. The receiver circuit of claim 14, wherein the one or more processing circuits include a combining weight generator configured to generate combining weights as a function of the impairment correlation estimates, for use in combining antenna-specific signal samples obtained from the OFDM signal.

17. The receiver circuit of claim 1 6, wherein the receiver circuit further includes or is associated with additional signal processing circuits that are configured to process the combined antenna-specific signal samples as a combined signal for at least one of transmit data decoding and received signal quality estimation.

18. The receiver circuit of claim 14, wherein the receiver circuit is configured to determine the received signal correlation estimates and calculate the impairment correlation estimates on an OFDM chunk basis, wherein each OFDM chunk spans a number of OFDM symbol times and spans a number of OFDM sub-carrier frequencies.

19. The receiver circuit of claim 18, wherein the channel estimates are generated on an OFDM chunk basis.

20. The receiver circuit of claim 18, wherein determining the received signal correlation estimates on an OFDM chunk basis comprises determining the received signal correlation estimates for an OFDM chunk using the data sub-carriers in that OFDM chunk, and wherein calculating the impairment correlation estimates on an OFDM chunk basis comprises determining the impairment correlation estimates for an OFDM chunk based on the received signal correlation estimates determined for the data sub-carriers in that OFDM chunk.

21. The receiver circuit of claim 20, wherein the receiver circuit is configured to generate the channel estimates on an OFDM chunk basis by generating channel estimates for an OFDM chunk using the pilot sub-carriers in that OFDM chunk.

22. The receiver circuit of claim 20, wherein the receiver circuit is configured to generate the channel estimates across OFDM chunks by generating channel estimates for an OFDM chunk using the pilot sub-carriers in that OFDM chunk and one or more pilot sub-carriers from one or more other OFDM chunks, or by combining channel estimates across two or more OFDM chunks.

23. The receiver circuit of claim 14, wherein the receiver circuit is configured to determine received signal correlation estimates for the OFDM signal across the receiver antennas based on data sub-carriers in the OFDM signal by determining a covariance of the OFDM signal as a function of received signal samples obtained from a number of data sub-carriers of interest in the OFDM signal.

24. The receiver circuit of claim 23, wherein the receiver circuit is configured to calculate impairment correlation estimates for the OFDM signal across the receiver antennas based on the channel estimates and the received signal correlation estimates by determining desired signal correlation estimates for a desired signal component of the OFDM signal based on the channel estimates, and determining the impairment correlation estimates based on the received signal correlation estimates and the desired signal correlation estimates.

25. The receiver circuit of claim 24, wherein the receiver circuit is configured to scale the channel estimates for traffic-to-pilot power differences, as part of determining the desired signal correlation estimates from the channel estimates.

26. The receiver circuit of claim 23, wherein the receiver circuit is configured to determine a covariance of the OFDM signal as a function of received signal samples obtained from a number of data sub-carriers of interest in the OFDM signal by, for a number of OFDM data sub-carrier frequencies of interest, summing products of received signal samples and corresponding conjugates over a number of OFDM symbol times of interest.

27. The receiver circuit of claim 14, wherein the OFDM signal comprises a low pilot density signal having a pilot density at or below ten percent.

28. A wireless communication device including the receiver circuit of claim 14.

29. A method of estimating impairment correlations between receiver antennas of an Orthogonal Frequency Division Multiplexing (OFDM) receiver, the method comprising:
receiving an OFDM signal at each of two or more receiver antennas;
generating channel estimates for the OFDM signal as received at each of two or more receiver antennas based on pilot sub-carriers of the OFDM signal;
determining received signal correlation estimates for the OFDM signal across the two or more receiver antennas based on data sub-carriers of the OFDM signal;
determining desired signal correlation estimates for the OFDM signal across the two or more receiver antennas based on the channel estimates; and
determining impairment correlation estimates for the OFDM signal across the two or more receiver antennas based on the received signal correlation estimates and the desired signal correlation estimates.

30. The method of claim 29, further comprising determining the received and desired signal correlation estimates on an OFDM chunk basis.
